(19) United States
(12) Patent Application Publication
(10) Pub. No.: US 2008/0266692 A1
(43) Pub. Date: Oct. 30, 2008

(54) MAGNETIC DISK DEVICE AND DATA WRITING METHOD THEREOF

(75) Inventors: Hitoshi Komoriya, Kawasaki (JP); Michinaga Yamagishi, Kawasaki (JP); Toru Yokohata, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/110,177

(22) Filed: Apr. 25, 2008

(30) Foreign Application Priority Data
Apr. 27, 2007 (JP) 2007-120063

(51) Int. Cl. G11B 5/02; G11B 27/36; G11B 21/02

(52) U.S. Cl. 360/31; 360/55; 360/75

(57) ABSTRACT

A data writing method to write data on a disk in a disk device. The data is written in one radial direction. The method includes detecting a first deviation amount from a center in a current track and sector in the direction of a track on which data was previously written. A second deviation amount from the center in the current track and sector in the direction of a track on which data will be subsequently written is also detected. Data is written on the current track when the first deviation amount is equal to or smaller than a first threshold and the second deviation amount is equal to or smaller than a second threshold.

The present application describes a disk device to write data on a disk in one radial direction.

### BACKGROUND

An ordinary disk device is capable of randomly writing data on a disk in a radial direction (also called “track direction”). For example, in FIG. 7, a moving direction of a head relative to a disk is indicated in the vertical direction, and a radial direction of the disk is indicated in the horizontal direction.

Referring to FIG. 7, 4-bit data is written on the track at the position indicated by (1) at the center, 4-bit data is written on the track at the position indicated by (2) on the right, and 4-bit data is written on the track at the position indicated by (3) on the left. However, in the ordinary disk illustrated in FIG. 7, a write order among tracks is not determined in the radial direction of the disk, and thus it is not determined in usual cases whether data on each track is overwritten with data on the immediate-right track or on the immediate-left track. In other words, track access is random.

For this reason, a gap of about 10% of a track pitch is provided between writing patterns (pieces of data written on respective tracks), as illustrated in FIG. 7. That is, if the position of a write head deviates from the track center by 15% of the track pitch, for example, write on the next track is not immediately performed, and whether write on the next track is to be performed thereafter is determined after a turn of the disk.

Patent Document 1 Japanese Laid-open Patent Publication No. 2001-143202 discloses a disk device having firmware that is modified to write data on a disk in one radial direction in order to increase the recording density and storage capacity. An example of such a disk device is an archive magnetic disk device.

In the disk device to write data on a disk in one radial direction, a data writing direction is predetermined: from the inner side to the outer side of the disk or from the outer side to the inner side of the disk. For example, in FIG. 8, a moving direction of a head relative to a disk is indicated in the vertical direction, and a radial direction of the disk is indicated in the horizontal direction.

In the disk device illustrated in FIG. 8, 4-bit data is written on the track at the position (1), 4-bit data is written on the track at the position (2), and 4-bit data is written on the track at the position (3). Thus, the data on the track at the position (1) is partially overwritten with the data at the position (2), and the data at the position (2) is partially overwritten with the data at the position (3).

In the write illustrated in FIG. 8, unlike in that illustrated in FIG. 7, the write order is predetermined and thus the track pitch required to maintain data quality can be decreased (narrowed).

However, when a write off-track margin is set to 10% of the track pitch in order to suppress overwrite on an adjacent track, a decrease in track pitch causes a decrease in write off-track margin.

As described above, the disk device to write data on a disk in one direction realizes a larger data capacity compared to an ordinary disk device. However, if the track pitch is changed and if the head is positioned with existing logic, a decrease in write off-track margin causes a higher possibility that the width of an overwritten area will exceed the margin, as described above. As a result, a data unwritable rate can become high. When data cannot be written after a particular turn of the disk, whether data can be written can only be considered and determined after at least one more turn of the disk, so that more time is required to write data. In other words, the performance degrades. Furthermore, the decrease in track pitch typically degrades signal quality (e.g., bit error rate).

The present application has been made in view of the above-described circumstances and an object of this application is to provide a data writing method and an off-track margin setting method by a disk device for increasing performance and signal quality, a disk device, and an off-track margin setting device.

### SUMMARY

In accordance with an aspect of the invention, a data writing method is used to write data on a disk in a disk device. The data is written in one radial direction. The method includes detecting a first deviation amount from a center in a current track and sector in the direction of a track on which data was previously written. A second deviation amount from the center in the current track and sector in the direction of a track on which data will be subsequently written is also detected. Data is written on the current track when the first deviation amount is equal to or smaller than a first threshold and the second deviation amount is equal to or smaller than a second threshold.

### BRIEF DESCRIPTION OF THE DRAWINGS

FIG. 1 illustrates a configuration of a magnetic disk device according to an embodiment of the present application;

FIG. 2 illustrates a first threshold of a deviation amount from a track center in a current sector in the direction of a track on which data has been previously written;

FIG. 3 illustrates a second threshold of a deviation amount from a track center in a current sector in the direction of a track on which data is to be subsequently written;

FIG. 4 is a flowchart of a data writing process;

FIG. 5 is a flowchart of a process of setting an off-track margin, which is an allowance in the direction of a track on which data is subsequently written;

FIG. 6 illustrates deviation ranges;

FIG. 7 illustrates write of data on tracks in a random-access disk device; and

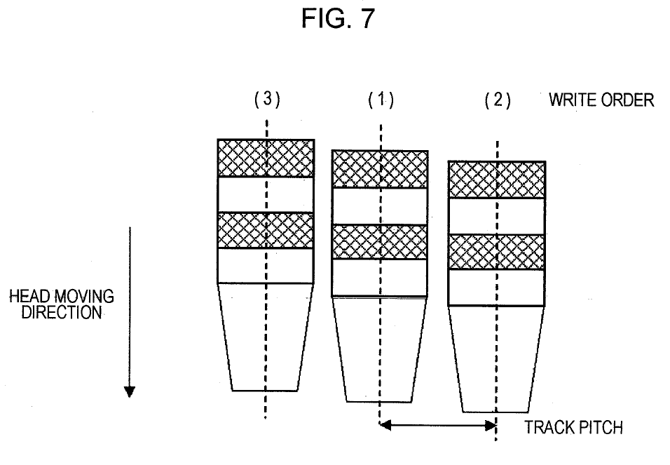

FIG. 8 illustrates write of data on tracks in a conventional disk device of a unidirectional writing type.

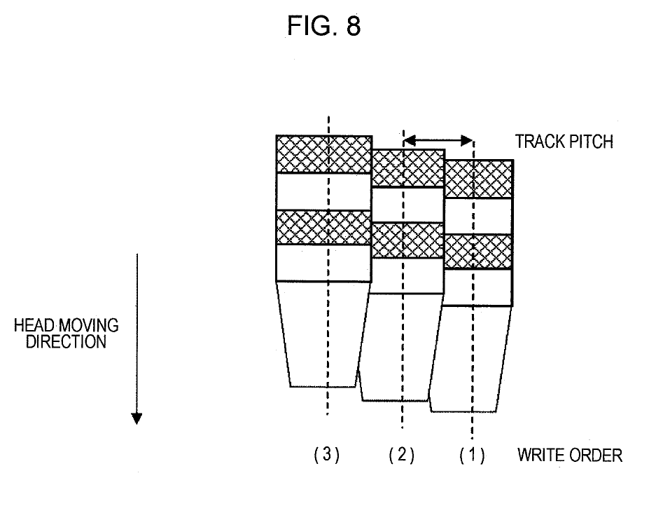

### DETAILED DESCRIPTION

Hereinafter, an embodiment of the present application is described with reference to the drawings.

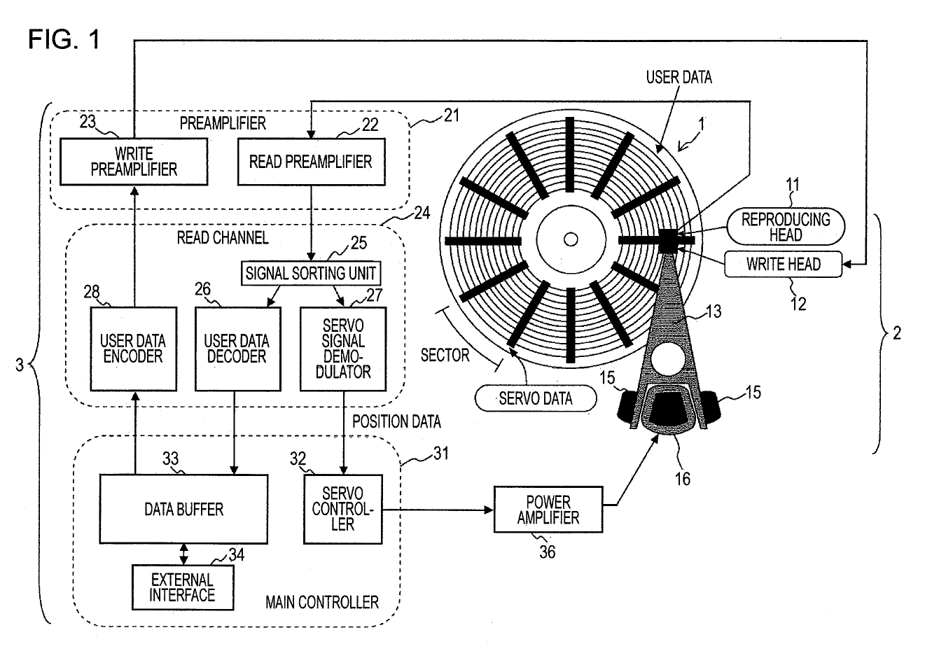

FIG. 1 illustrates a configuration of a magnetic disk device according to an embodiment. The magnetic disk device includes a disk 1 on/from which user data is written/read (accessed); a head moving mechanism 2 to position a head on each track of the disk 1; and a control unit 3 to control access to user data on the disk 1. The user data is data on the disk 1 other than servo data.

On the disk 1, a plurality of tracks are placed in a radial direction, and servo data (a position error signal, also called “PES”) is recorded on the respective tracks.

For example, serial numbers are assigned to the respective tracks in ascending order from the inner side to the outer side. The servo data is given as a set of the serial number and the amount of deviation from the track center of a head position.

The head moving mechanism 2 includes a head unit including a reproducing head 11 and a write head 12; a carriage 13 attached with the head unit at its end; and magnets 15 and a voice coil 16 to position the head unit by rotating the carriage 13 around an axis illustrated as a white circle. For synchronization of a response of the head moving mechanism 2, a desired position several sectors ahead from a current (immediately after) sector is written in the servo data.

The reproducing head 11 is positioned above the write head 12 in FIG. 1. The reproducing head 11 reads data in each sector of the disk 1 that rotates clockwise. The write head 12 writes user data (a magnetization signal corresponding to “0” or “1”) in each sector of the tracks.

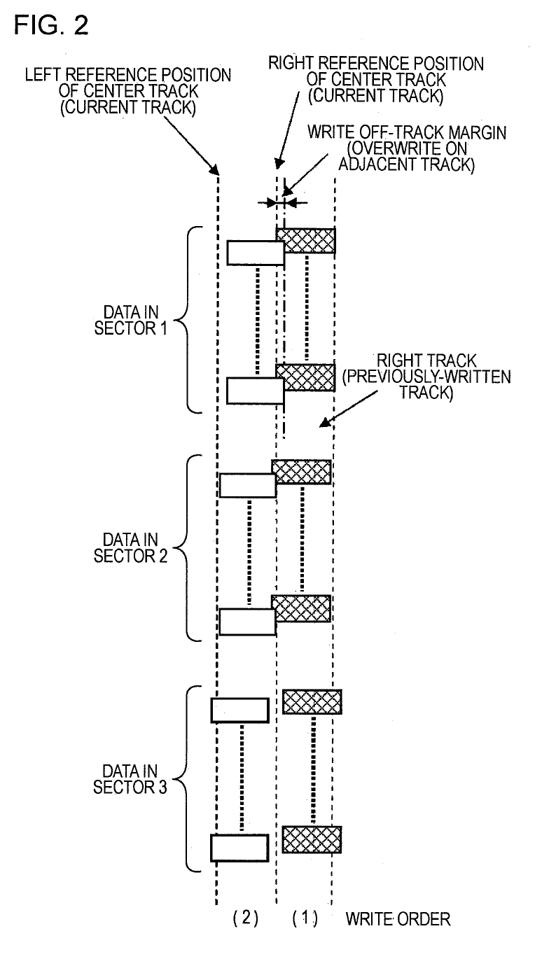

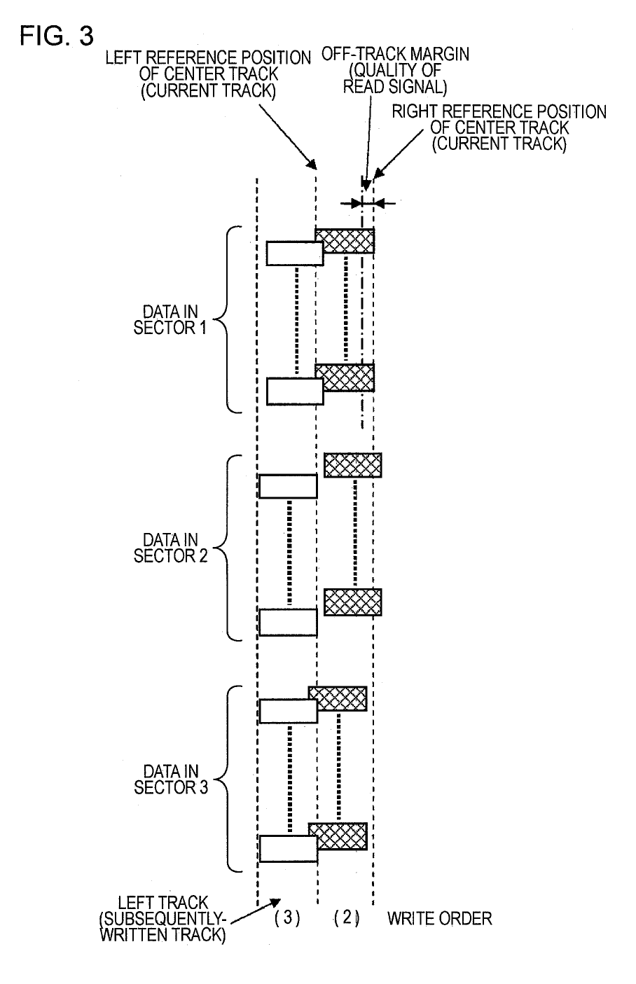

In the following description, it is assumed that the head is positioned on the right of the disk, as illustrated in FIG. 1, and that data is written on the disk in one radial direction from the outer side to the inner side. Thus, in FIGS. 2 and 3 described below, the data on the right side corresponds to the data written on an outer track of the disk.

The control unit 3 includes a preamplifier 21; a read channel 24; and a main controller 31.

The preamplifier 21 includes a read preamplifier 22 to amplify data (user data or servo data) read by the reproducing head 11 and output the amplified data to the read channel 24; and a write preamplifier 23 to amplify (encoded) user data and output the amplified data to the write head 12.

The read channel 24 includes a signal sorting unit 25 to sort output signals of the read preamplifier 22 to any of user data and servo data; a user data decoder 26 to decode sorted user data and output the decoded data to a data buffer 33; a servo signal demodulator 27 to demodulate sorted servo data and output the demodulated data as position data to a servo controller 32; and a user data encoder 28 to encode user data to be written on the disk 1.

The main controller 31 includes the servo controller 32; the data buffer 33; and an external interface 34.

The servo controller 32 generates a control signal to adjust the position of the head unit based on the position data (the serial number of a current track and a deviation amount from the track center in the track) from the servo signal demodulator 27. This control signal is output to the head moving mechanism 2 via a power amplifier 36, so that the position in the radial direction of the head unit is adjusted.

The data buffer 33 stores user data decoded by the user data decoder 26 and also stores user data to be encoded by the user data encoder 28. The user data buffered in the data buffer 33 is transmitted/received to/from the outside via the external interface 34.

Conventionally, as illustrated in FIG. 2, it is only determined whether a deviation amount from the track center in the current track is equal to or smaller than a first threshold in the direction of the track on which data was previously written (the track on the immediate right). Therefore, if the deviation amount from the track center is large in the direction of the track on which data is subsequently written (the track on the immediate left), the quality (e.g., bit error rate) of user data degrades disadvantageously. Note that the first threshold may be called “write off-track margin, which is an allowance (for overwrite) in the direction of the track on which data was previously written” or simply called “write off-track margin”.

In this embodiment, as illustrated in FIG. 3, it is also determined whether the deviation amount from the track center, obtained from the servo data, in the current track and sector is equal to or smaller than a second threshold, larger than the first threshold, in the direction of the track on which data is subsequently written (track on the immediate left). Then, if it is determined that the deviation amount from the track center in the current track is equal to or smaller than the first threshold in the direction of the track on which data was previously written and is equal to or smaller than the second threshold in the direction of the track on which data is subsequently written, writing data on the current track is performed.

On the other hand, if it is determined that the deviation amount from the track center obtained from the servo data is larger than the first threshold or larger than the second threshold, whether data is to be written on the same track and sector is determined again after a turn of the disk.

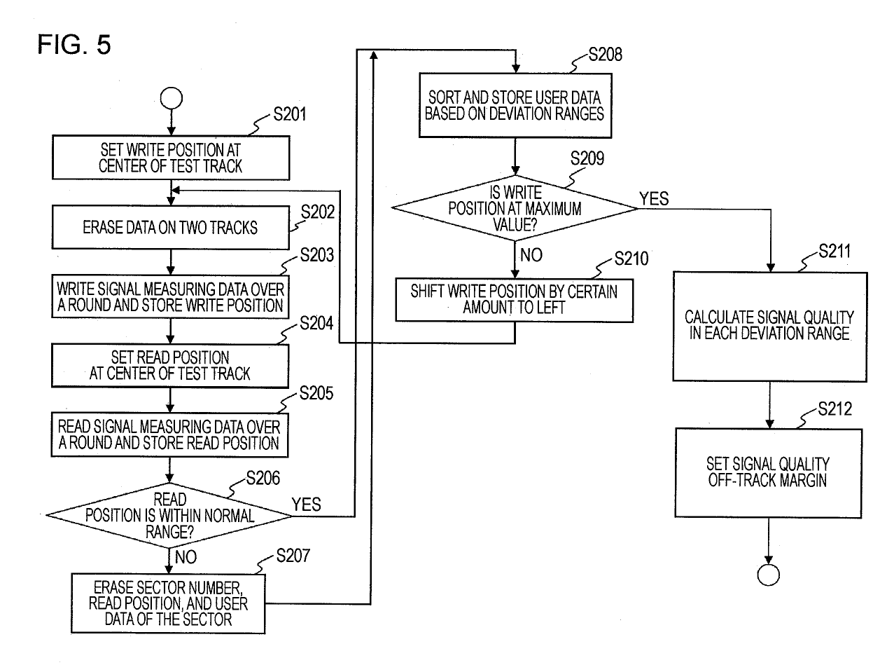

An appropriate second threshold can be set by using a test method illustrated in FIG. 5. The second threshold is a maximum shift amount in the direction of the track on which data is subsequently written, the shift amount satisfying a reference value (e.g., one or less error bit out of 10000 bits) of signal quality (e.g., bit error rate) to test data (signal measuring data). As a result of a test, the second threshold is about three to five times larger than the first threshold.

In accordance with the above-described means, the second threshold may be called “off-track margin, which is an allowance in the direction of the track on which data is subsequently written” or “signal quality (reference) off-track margin”.

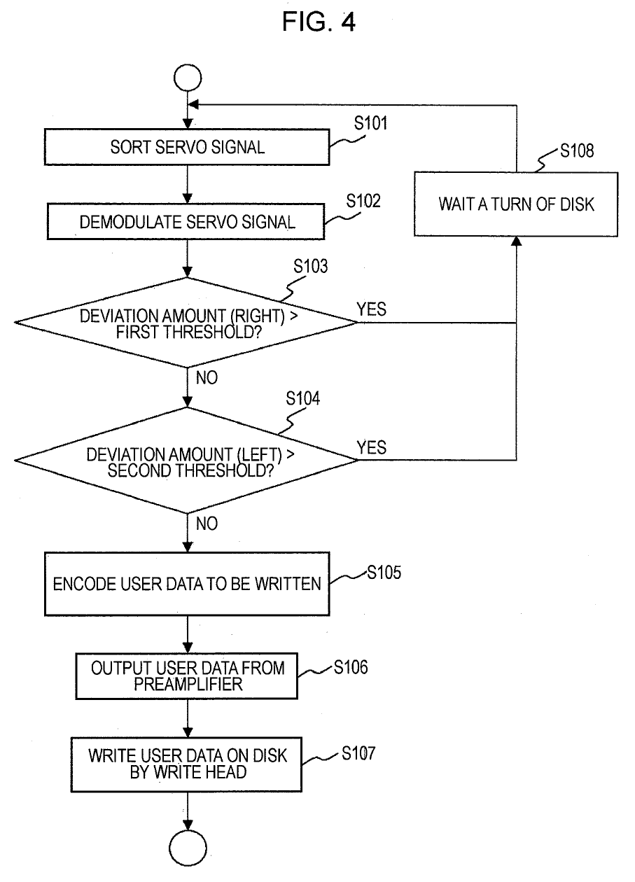

FIG. 4 is a flowchart of a data writing process. The unit performing determination in steps S103 and S104 exists in the servo controller 32.

In step S101 in FIG. 4, data on the disk 1 read by the read preamplifier 22 illustrated in FIG. 1 is sorted into user data and servo data (servo signal) by the signal sorting unit 25. At this time, when a servo signal is detected, the servo signal is demodulated by the servo signal demodulator 27 in step S102, so that position data (the serial number of the current track and the deviation amount from the track center in the track) can be obtained.

In step S103, it is determined whether the deviation amount in the position data is larger than the first threshold in the direction of the track on which data is previously written.

If it is determined in step S103 that the deviation amount is larger than the first threshold, the process proceeds to step S108 to wait a turn of the disk 1, and the process returns to step S101.

If it is determined in step S103 that the deviation amount is equal to or smaller than the first threshold, the process proceeds to step S104, where it is determined whether the deviation amount is larger than the second threshold (signal quality (reference) off-track margin) in the direction of the track on which data is subsequently written.

If it is determined in step S104 that the deviation amount is larger than the second threshold, the process proceeds to step S108 to wait a turn of the disk (medium) 1, and the process returns to step S101. During the waiting, the head is positioned on the track where the data is to be written on the basis of the servo signal.

If it is determined in step S104 that the deviation amount is equal to or smaller than the second threshold, the process proceeds to step S105, where the user data to be written is encoded by the user data encoder 28. In step S106, the encoded user data is output from the write preamplifier 23 to the write head 12. Then, in step S107, the user data is written on the disk 1 by the write head 12.

FIG. 5 is a flowchart of a process of setting an off-track margin, which is an allowance in the direction of the track on which data is subsequently written. In this flowchart, test data is prepared for two sequential tracks on the disk, and the bit error rate of the track (test track) on which data is written first among those tracks is measured.

In step S201 in FIG. 5, a write position is set at the center (the position where the shift amount is 0) of the test track. Then, in step S202, data on the two tracks including the test track is erased.

In step S203, signal measuring data is written on the test track over a round. At this time, the numbers of sectors and the write positions of data in the sectors are stored in a memory. Then, data is written on the track adjacent to the test track over a round so as to overwrite the test track. The data writing is performed based on the first threshold illustrated in FIG. 2.

In step S204, a read position is set at the center of the test track. Then, in step S205, the signal measuring data on the test track is read over a round. At this time, the numbers of sectors, the read positions of data in the sectors, and user data as a decoded result are stored in the memory.

In step S206, it is determined whether the read position in each sector stored in the memory in step S205 is within a normal range.

If it is determined in step S206 that the read position is out of the normal range in any of the sectors, the sector number, the read position, and user data of that sector are erased in step S207, and then the process proceeds to step S208.

If it is determined in step S206 that the read position is within the normal range in all the sectors, the process proceeds to step S208.

In step S208, the numbers of sectors and the write positions of data in the sectors written in the memory in step S203 are obtained and the user data as a decoded result written in the memory in step S205 is also obtained, and then the write position and user data of each sector are written in the memory.

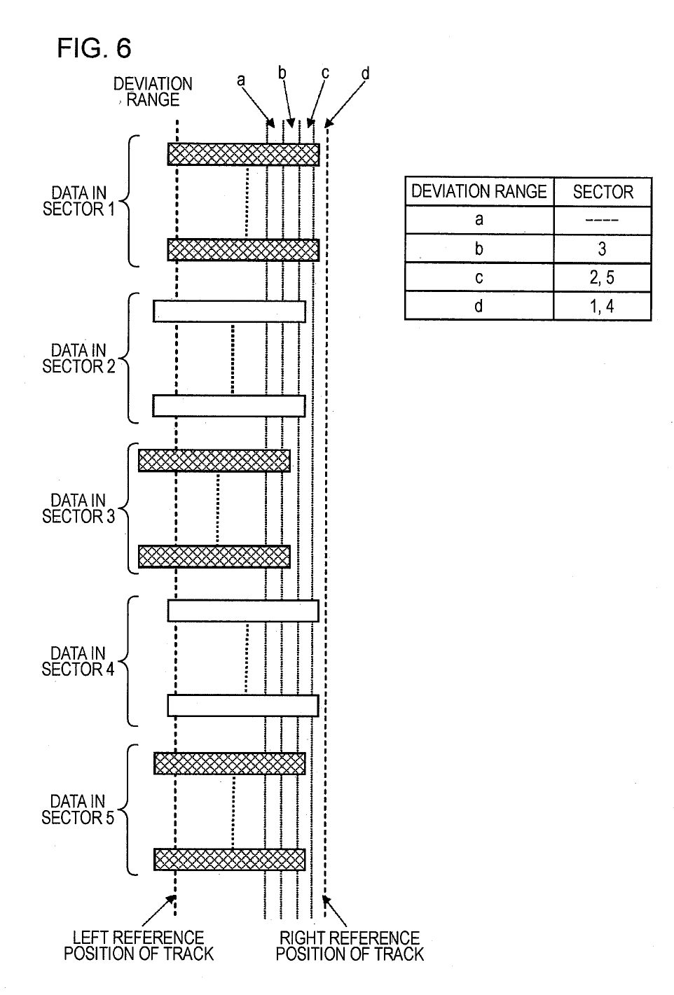

Then, the user data as a decoded result is sorted based on preset deviation ranges to which the respective write positions belong, as illustrated in FIG. 6. The example illustrated in FIG. 6 corresponds to a case where the shift amount is zero, and thus only a, b, c, and d are shown as the deviation ranges. Each of the deviation ranges indicates how much the end of user data deviates from the end of the test track opposite to the overwriting track with reference to the write position.

Then, in step S209, it is determined whether the write position is at the maximum value.

If it is determined in step S209 that the write position is not at the maximum value, the process proceeds to step S210, where the write position is shifted by a certain shift amount in the direction of the track on which data is subsequently written, and then steps S202 to S209 are performed. By repeating the shift, deviation ranges e, f, g, h, . . . (not shown) are added to the deviation ranges illustrated in FIG. 6.

If it is determined in step S209 that the write position is at the maximum value, the process proceeds to step S211, where comparison with the original user data used in the test is performed in each deviation range so as to calculate the bit error rate (signal quality) in each deviation range.

In step S212, the value corresponding to a maximum deviation range satisfying the reference of the bit error rate (e.g., one or less error bit out of 10000 bits) is set as the above-described second threshold (signal quality off-track margin).

What is claimed is:

1. A data writing method to write data on a disk in a disk device, the data being written in tracks and sectors in one radial direction of the disk, the method comprising:
detecting a first deviation amount from a center in a current track and sector in the direction of a track on which data was previously written;
detecting a second deviation amount from the center in the current track and sector in the direction of a track on which data is to be subsequently written; and
writing data on the current track when the first deviation amount is equal to or smaller than a first threshold and when the second deviation amount is equal to or smaller than a second threshold.

2. The data writing method according to claim 1, wherein the second threshold is a value within a bit error rate as a set signal quality reference.

3. The data writing method according to claim 1, wherein, when the first deviation amount is larger than the first threshold or when the second deviation amount is larger than the second threshold, whether data can be written in the current sector is determined again after a turn of the disk.

4. A method for setting an off-track margin in the direction of a track on which data is subsequently written in a disk device, the disk device writing data on a disk in tracks and sectors in one radial direction, the method comprising:
writing signal measuring data on a target track;
storing a write position of the signal measuring data;
writing overwrite data in a position deviating in one radial direction from the center of the target track;
reading the signal measuring data in a plurality of positions having different deviation amounts in the other radial direction from the center of the target track;
storing the write position and a decoded result of the signal measuring data in the read position corresponding to the write position by associating the write position with the decoded result; and
setting a maximum deviation amount satisfying a signal quality reference as the off-track margin.

5. The method according to claim 4, wherein the signal quality reference is set with reference to a bit error rate.

6. A magnetic disk device to write data on a disk in one radial direction, comprising:
a first determining unit to determine whether a first deviation amount from a track center in a current track in the direction of a track on which data was previously written is larger than a first threshold;
a second determining unit to determine whether a second deviation amount from the track center in the current track in the direction of a track on which data is subsequently written is larger than a second threshold; and
a control mechanism to write data on the current track when the first determining unit determines that the first deviation amount is equal to or smaller than the first threshold and when the second determining unit determines that the second deviation amount is equal to or smaller than the second threshold.

7. The disk device according to claim 6, wherein, when the first determining unit determines that the first deviation amount is larger than the first threshold or when the second determining unit determines that the second deviation amount is larger than the second threshold, the first and second determining units determine again a relationship between the deviation amounts and the thresholds after a turn of the disk.

8. The disk device according to claim 6, wherein the second threshold is larger than the first threshold.
